(19) United States
(12) Patent Application Publication
(10) Pub. No.: US 2012/0000257 A1
(43) Pub. Date: Jan. 5, 2012

(54) Single and multi-point door lock

(75) Inventors: Thomas J. Wheeler, Pomona, CA (US); William Chung-Sum Chow, Rowland Heights, CA (US)

(73) Assignee: Adams Rite Manufacturing Co.

(21) Appl. No.: 12/803,585

(22) Filed: Jul. 1, 2010

(51) Int. Cl. E05B 65/00; E05C 3/14

(52) U.S. Cl. 70/91; 292/200; 292/226

(57) ABSTRACT

In a lock drive train, the combination includes a pivoted lock bolt to be carried by a door, a casing, a rotary cylinder operatively rotatable during door opening or closing, a rack driven endwise in response to cylinder rotation, a gear rotatable by the driven rack, a pivoted lock dog driven by the gear, a bolt release lever, pivotable by the gear, between angular positions in which it is retained by the lock dog, the angular positions corresponding to extended and retracted positions of the bolt.

### BACKGROUND OF THE INVENTION

This invention relates generally to single and multi-point locking apparatus for doors, and more particularly to a highly advantageous apparatus incorporating a simple, reliable, element drive train between an adjustable position manually rotatable lock cylinder, and pivoted lock bolt.

There is need for improvements in simple, reliable apparatus as referred to, and which is easily installed and adjustable in door frame structures. There is also need for the unusually effective and reliable combination of lock elements as is disclosed herein.

### SUMMARY OF THE INVENTION

It is a major object of the invention to provide improved apparatus, meeting the above needs. Basically, the apparatus comprises a lock drive train comprising:

a) a pivoted lock bolt to be carried by a door,

b) a casing,

c) a rotary cylinder operatively rotatable during door opening or closing,

d) a rack driven endwise in response to cylinder rotation,

e) a gear rotatable by the driven rack,

f) a pivoted lock dog driven by the gear,

g) a bolt release lever, pivotable by the gear, between angular positions in which it is retained by the lock dog,

h) said angular positions corresponding to extended and retracted positions of the bolt.

As will appear, the lock dog typically has releasable interfit connection with the bolt, in bolt extended and retracted positions, there being a lost motion connection between the gear and the bolt release lever whereby said interfit is released during gear rotation and prior to said pivoting of the release lever. In addition, spring means is provided to bias the lock dog to retain said releasable interfit, in bolt extended and retracted positions.

Another object is to provide a gear as referred to, which has multiple functions in the drive train, as respects both driving the bolt release lever, with lost motion connection; and also driving the lock dog in timed relation to the lost motion drive of the bolt release lever. The latter typically has pin and slot interconnection to the bolt.

A further object is to provide an improved pivotable bolt having a through opening between opposite sides of the bolt, and a roller received in that opening to protrude at opposite sides of said body,
i) for rollable engagement with a confinement surface or surfaces associated with the casing, during bolt pivoting,
ii) or, for engagement by a hack saw operated by an intruder, for blocking severing of the bolt.

An added object is to provide a lock cylinder having multiple threads, and a casing housing the cylinder and configured to be mounted within an opening in a door, and including a non-cantilevered locking set screw received in engagement with said threads.

A yet further object is to provide a lock faceplate having beveled edges interfitting corresponding edges defined by an opening in the casing, the faceplate being removable to provide access to said set screw, for adjustment.

Another object includes provision of a bolt that has at least one tapered side surface to assure ease of interfit in the casing, as the bolt pivots.

An additional object is to provide an elongated stile containing the casing, and spacers installed and located within the stile in response to relative sliding, for positioning the casing, said spacers configured to be adjustable during installation in the field, to retain the casing positioning in the stile, and a removable trim facing plate for the casing to conceal such spacers.

A further object is to provide a dummy face plate on the stile used during said adjustable positioning, to allow spacer alignment and positioning via a tool insertable in an opening or openings in the dummy face plate, that dummy face plate then being removable to allow installation of said final trim face plate.

Another object is to provide a casing for the rotary cylinder, to fit in a door opening, and means to retain the casing in any of a plurality of selected horizontal positions in the door opening. Such means may typically comprise a first set of tongue and groove elements at the door opening, and being horizontally spaced, and at least one tongue or groove element or elements carried by the cylinder casing or door opening, to selectively interfit said first set.

Yet another object includes provision of a stile into which the lock casing is received, and means for adjusting the position of the casing relative to a stile wall, including a set screw carried by the lock casing and having threaded engagement with the casing whereby the screw exerts tightening force against the stile, the screw rotatable by an elongated adjuster inserted and projecting into the casing.

A yet further object includes provision of upper and lower elongated rod elements extending into the lock casing to be operatively connected to the lock bolt for extension as the bolt rotates, and upper and lower auxiliary bolts operatively connected to said rod elements at their terminals, to be displaced into door frame structure as the lock bolt is pivoted. In this regard, adjustable means is typically operatively connected between the upper auxiliary bolt and the upper rod, allowing vertical adjustment of upper bolt positioning in response to rod rotation, and fastener means to hold the adjustment means in position following adjustment. The rod elements are configurable for both 2 and 3 point configurations.

An additional object is to provide an improved lock having quick connect and/or disconnect capabilities.

These and other objects and advantages of the invention, as well as the details of an illustrative embodiment, will be more fully understood from the following specification and drawings, in which:

### DRAWING DESCRIPTION

FIG. 1 is a perspective view of a preferred lock apparatus incorporating the invention;

FIG. 2 is a vertical section taken through the FIG. 1 apparatus, and showing a blocked condition;

FIG. 3 is a view like FIG. 2, showing an unblocked condition;

FIG. 4 is a view like part of FIG. 2, showing elements in enlarged configuration;

FIG. 5 is a vertical section taken on lines 5-5 of FIG. 4;

FIG. 5a is a perspective view showing of a pinion drive element;

FIG. 6 is a perspective view showing of a lock cylinder element showing one end thereof;

FIG. 7 is a perspective view showing the cylinder case element, endwise reversed from FIG. 6;

FIG. 8 is a side view, partly in section, showing position relationship of the cylinder case, rack and pivot elements;

FIG. 9 is a view taken on lines 9-9 of FIG. 8;

FIG. 10 is a view taken on lines 10-10 of FIG. 8;

FIGS. 11a-11c are like views showing adjustable backset to accommodate different width frames;

FIG. 12 is a perspective view of a screw holder;

FIG. 13 is a frontal view of the FIG. 12 screw holder with assembled screw, attached to the lock case and cover elements;

FIG. 14 is a section taken on lines 14-14 of FIG. 13;

FIG. 15 is a view like FIG. 2, but showing inclusion of upper and lower lock bolt components;

FIG. 16 is an elevation showing inclusion of door structures, and associated upper and lower bolt connections;

FIG. 17 is an enlarged vertical elevation showing details of connection of an actuator to an upper rod that drives an upper bolt connection;

FIG. 18 is a section taken on lines 18-18 of FIG. 17;

FIG. 19 is an enlarged vertical elevation showing details of an upper bolt connected to a vertical actuator rod;

FIG. 20 is a horizontal section taken on lines 20-20 of FIG. 19;

FIG. 21 is a perspective view showing a lock bolt having a side roller to engage associated fixed structure, as the bolt is displaced;

FIG. 22 is a section taken on lines 22-22 of FIG. 21; and

FIG. 23 is a section taken on lines 23-23 of FIG. 21.

### DETAILED DESCRIPTION

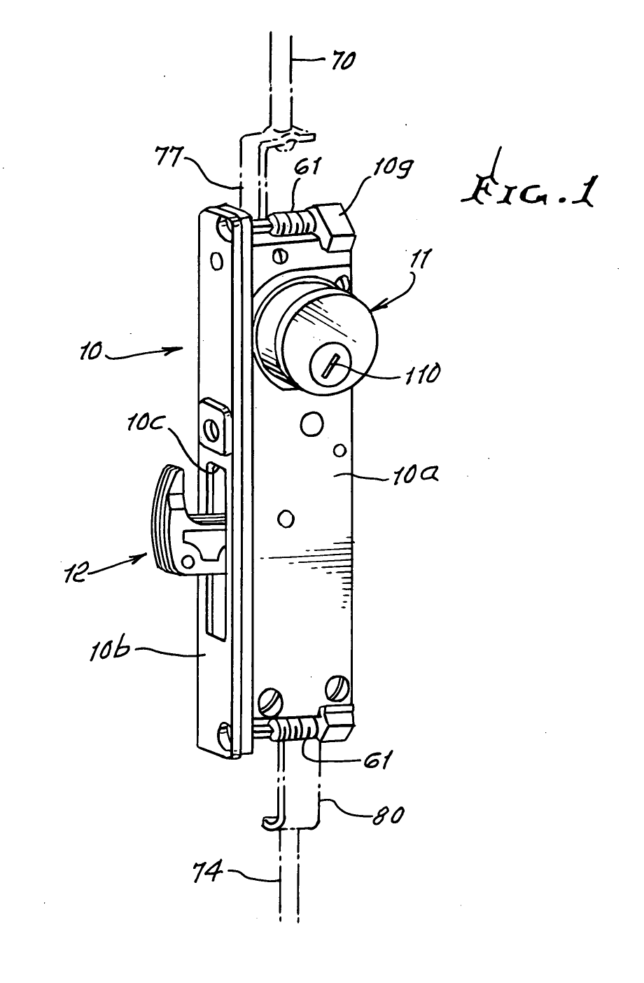

In FIGS. 1 and 2, a door lock housing 10 carries a lock cylinder 11 projecting at one side 10a of the housing and bolt 12 projecting at side 10b of the housing, extending at 90° to side 10a. Within the housing is an upright lock case 14 defining a side opening 14a registering with side opening 10c of the housing. Bolt 12 in locked position projects laterally through the openings 14a and 10c as shown and is rotatable about pivot 15 in response to rotation of cylinder 11, as shown in FIG. 2. Cylinder 11 may be provided with a key entry slot 110, as shown.

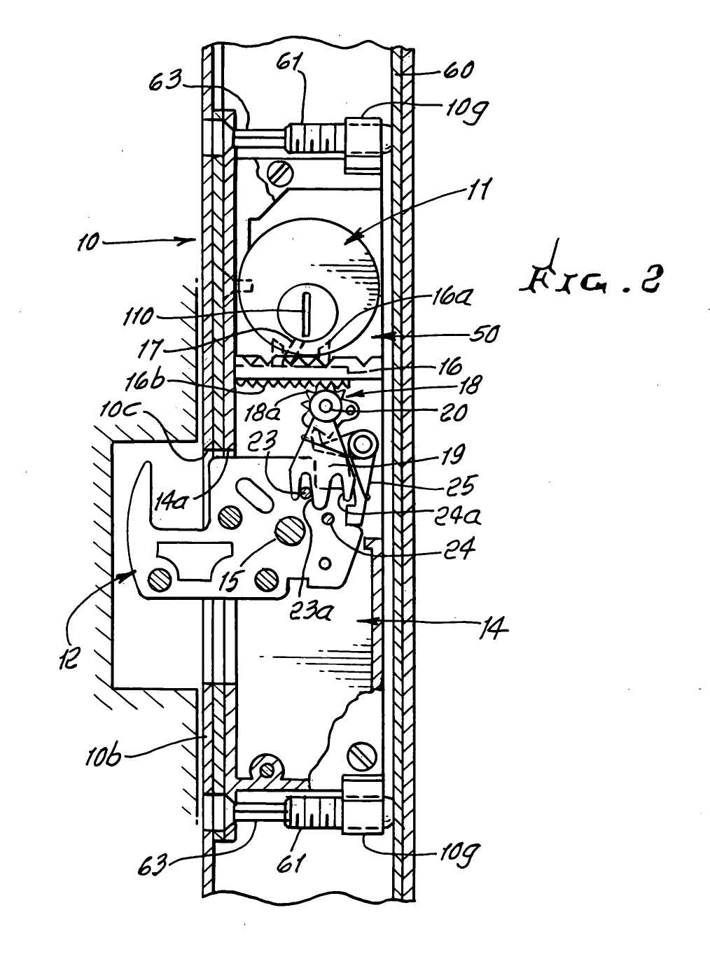

Mechanism operable between cylinder 11 and the bolt 12 includes an elongated rack 16 driven endwise by a cam or dog 17 downwardly projecting from the cylinder 11 to engage rack projection 16a at the rack upper side. A pinion gear 18 is located below the rack, and has teeth 18a engaging downwardly projecting rack teeth 16b. A link or parallel links 19 are pivoted at 20 along with the gear 18, and located at opposite sides of the gear. The links and gear are fixedly attached to the supporting pivot shaft 20, whereby the gear 18 rotates the links. Shaft 20 is rotatable in frame bearings 21. Links 19 are rotatable between end position as seen in FIGS. 2 and 4, in which bolt 12 is extended, and position as seen in FIG. 3, in which the bolt has been rotated about pivot 15, into retracted position.

Pins 23 and 24 projecting from the sides of the bolt slidably fit in slots 23a and 24a of the links, to rotate the bolt, as the links are swung by the gear 18.

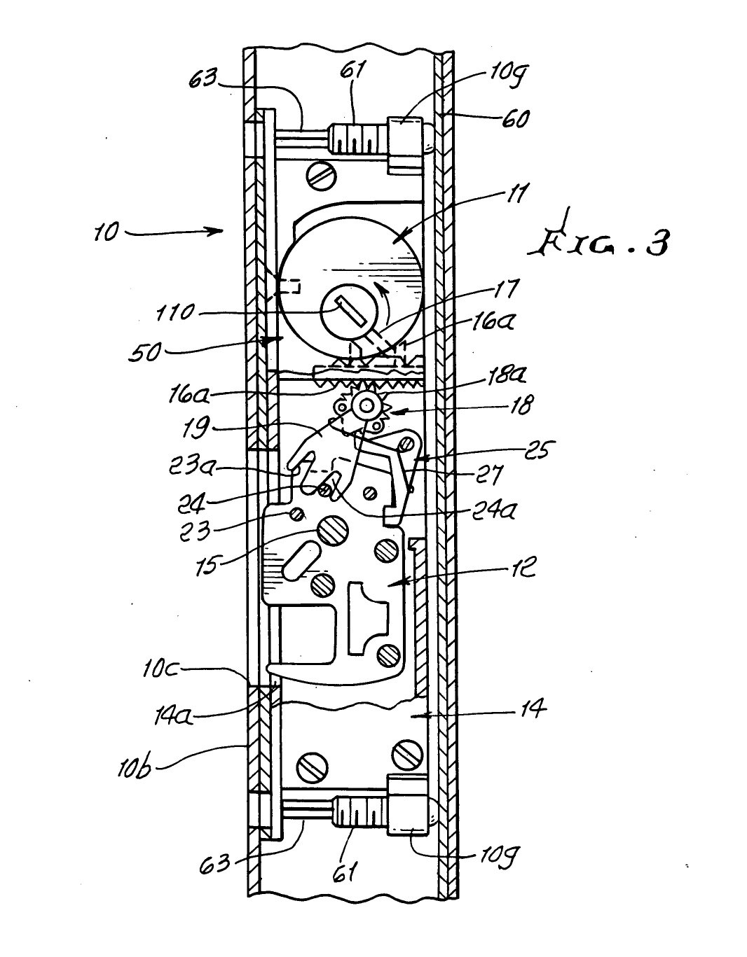

A locking dog or lever 25, urged by a torsion spring 27 (see FIG. 4), has a terminal 25a that fits in a notch 26 in the bolt body 18a to lock the bolt in extended position, and the terminal 25a fits in a notch 27 in the bolt body 18a to lock the bolt in FIG. 3 retracted position. During bolt activation from the ends of bolt angular swing travel, the arm 24c of the dog is depressed by a projection 28 extending downwardly from the gear, to pivot the dog 25 and release terminal 25a from each notch, as the gear commences its rotation from each of the gear and bolt positions of FIGS. 3 and 4, toward alternate position. Lost motion, as provided as by slots 23a and 24a, allows release of the terminal 25a from each notch prior to activation of bolt swinging, to assure release. See in this regard pins 30a and 30b on gear 18 (see FIG. 5a) which engage opposite edges 19a and 19b of lever or link 19, after the gear 18 has rotated to pivot dog 24 enough to release terminal 25a from either slot 26 and 27. Accordingly, gear 18 has multiple actuating functions which it controls.

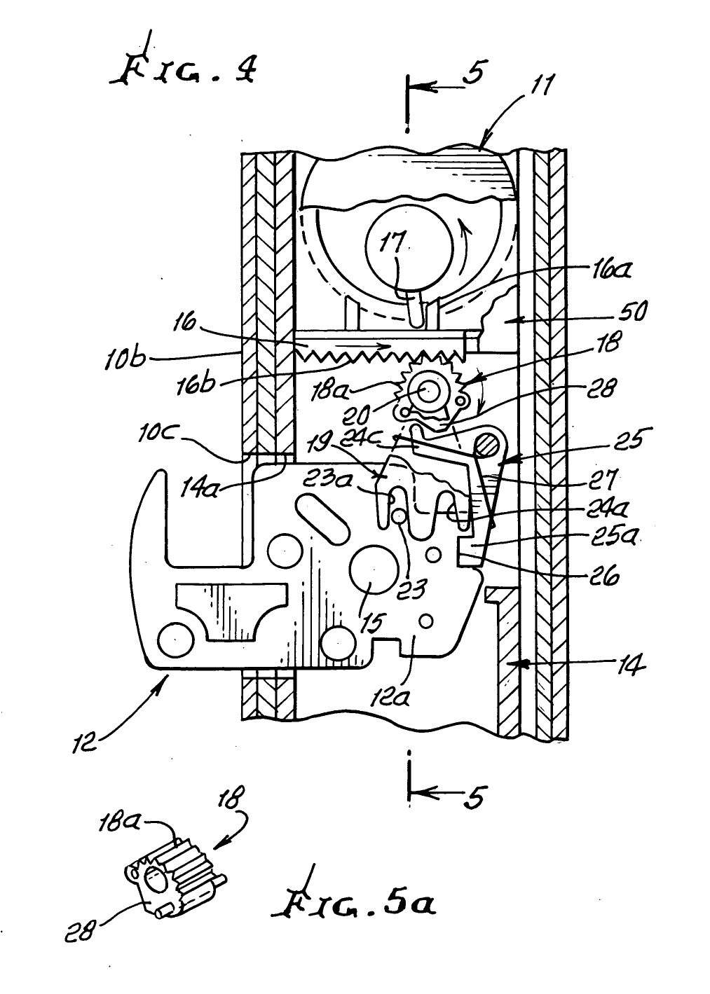

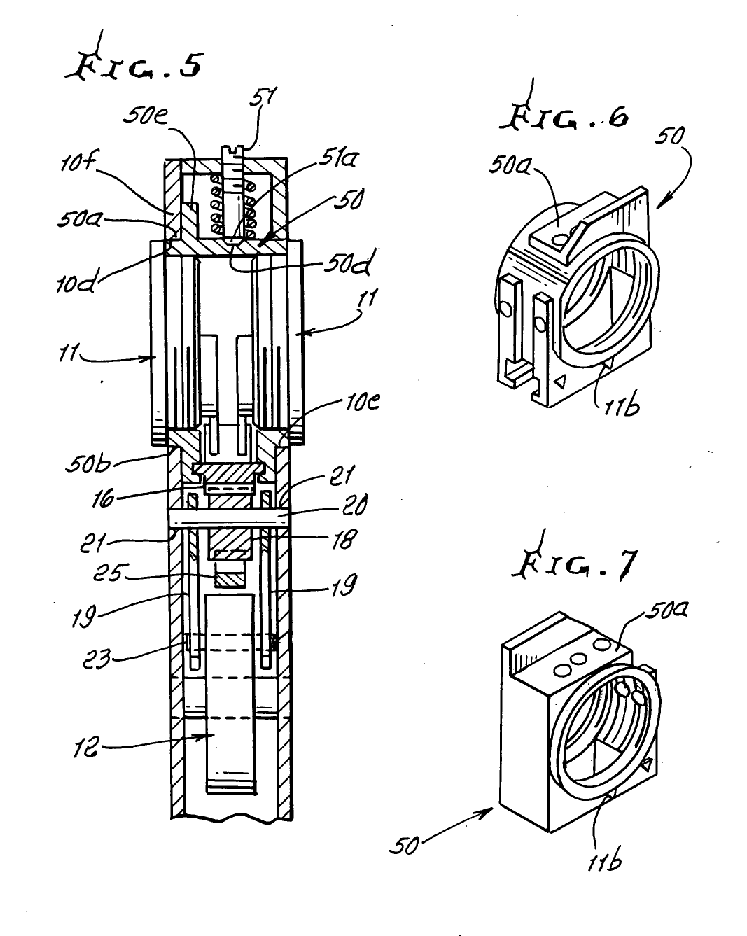

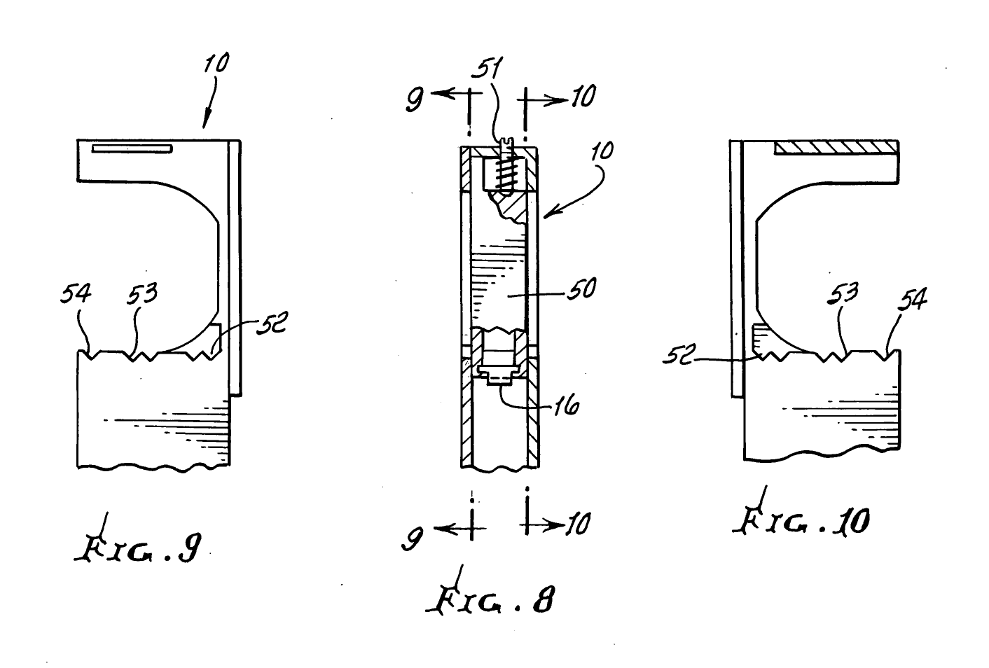

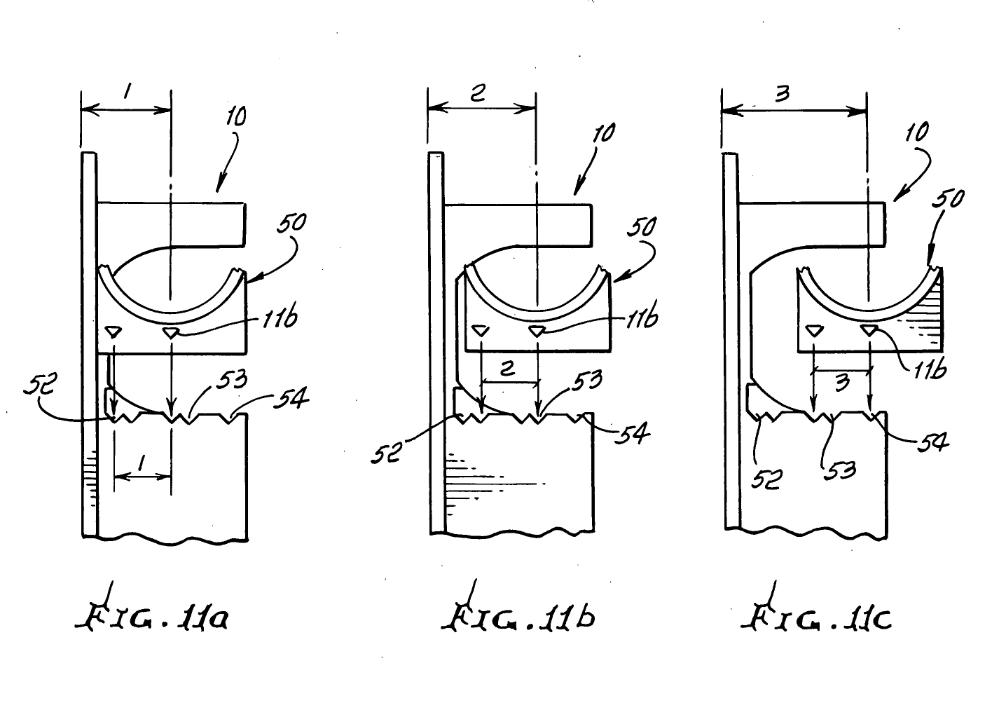

FIGS. 5-7 show the block-like casing 50 that receives the lock cylinder 11, and is installable in the frame or housing 10 to accurately position the cylinder 11 for rotation to actuate the rack 16. That casing 50 has upper and lower flat surfaces 50a and 50b that are to be retained between frame shoulders 10a and 10b, as seen in FIG. 5. A positioning screw 51 is adjustable to retain the casing 50 in position, the screw terminal 51a bearing on the case at 50d. Flange 50e bears against wall 10e. See also FIGS. 8-10, and FIGS. 11a-11c, which also show grooves 52-54 in the casing and horizontally spaced apart, as shown, to adjust the horizontal position (backset adjustment) of the lock cylinder, as related to a door opening that receives the cylinder 11. A tongue 11b on the cylinder projects downwardly to selectively fit into one of such grooves 52-54. Accordingly, a first set of tongue or groove elements is provided at the door opening, and which are horizontally spaced, and at least one tongue or groove element or elements is carried by the cylinder casing or door opening, to selectively interfit a groove or tongue element of said first set. FIGS. 11a-11c show accommodation to frames 1, 2 and 3 of different widths.

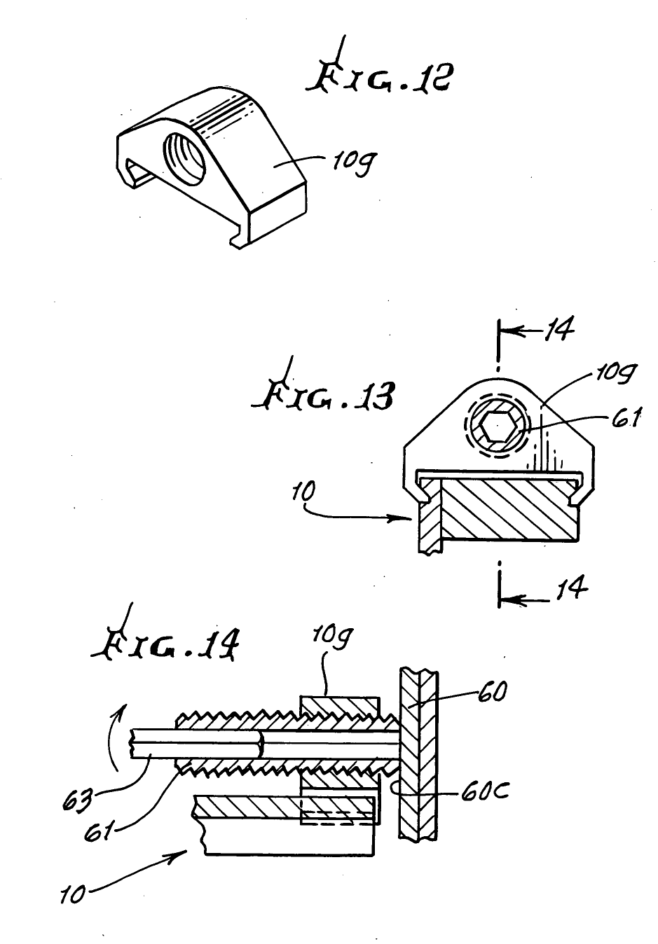

FIGS. 12-14 show provision of a means for retaining the lock housing or frame 10 in an adjusted horizontal position relative to an upright door stile 60 that receives that housing. The frame has a portion 10d that threadably receives, at 10e, a spacer or pusher 61 endwise bearing endwise against the inner side 60a of vertical door stile 60. An adjuster 63 projects into the screw interior, with hexagonal interfit, so that as the adjuster is rotated, the screw tightens endwise against surface 60c, and simultaneously adjusts the position of the frame 10, horizontally, relative to the stile. The thin endwise elongated adjuster may be inserted into the lock frame via a suitable small opening in the frame wall.

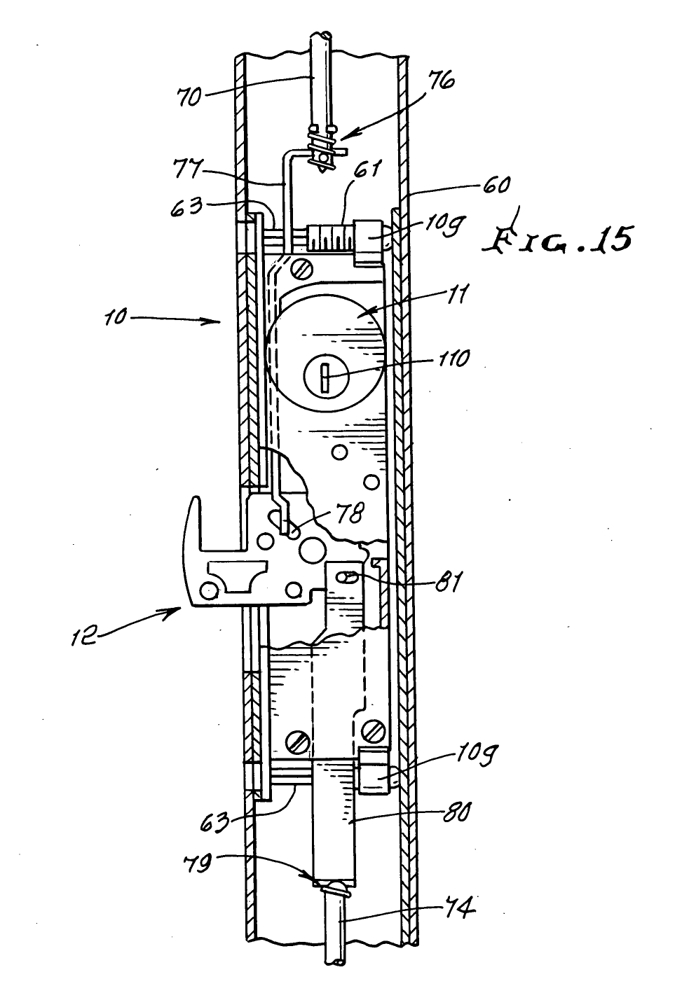

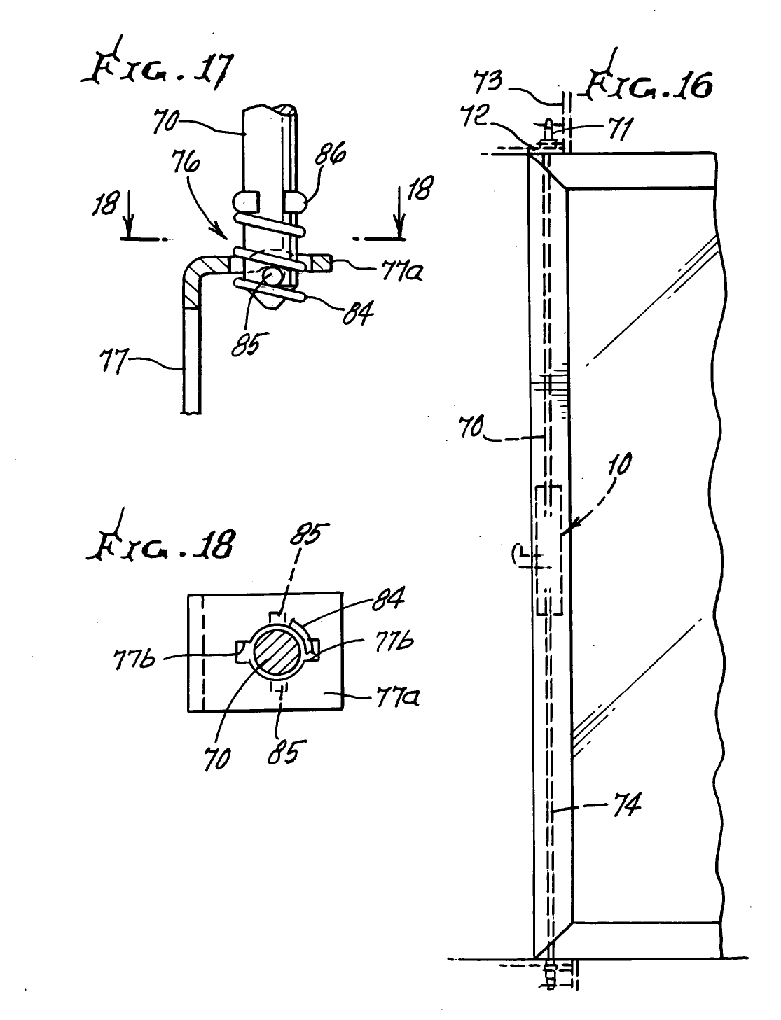

FIGS. 15-20 show provision of means to adjustably bolt connect the lock housing to structure immediately above and below the door frame, and to be actuated in response to bolt 12 rotation to lock the door. Upper vertical rod 70 is displaced upwardly in response to bolt 12 rotation, to urge upper bolt 71 into a recess 72 in door upper frame structure 73; and lower vertical rod 74 is displaced downwardly in response to said bolt rotation, which locks the door. Rod 70 is operatively connected, at 76 to an upper intermediate rod 77 which extends downwardly within the lock housing and into a recess 78 in the bolt 12, to be urged upwardly as the bolt rotates counterclockwise in FIG. 15; and rod 74 is operatively connected at 79 to a lower intermediate rod 80, which extends upwardly into the lock housing and has an interfit connection at 81 with the bolt, to be urged downwardly as the bolt rotates counterclockwise. Connection 76 is preferably a “quick release” connection to be made up after installation of the lock in door stile 60. FIGS. 17 and 18 show a spring 84 on rod 70 as compressed between a pin 85 on lateral extension 77a of rod 77, and a pin 86 on rod 70. Spring 84 stiffens the connection.

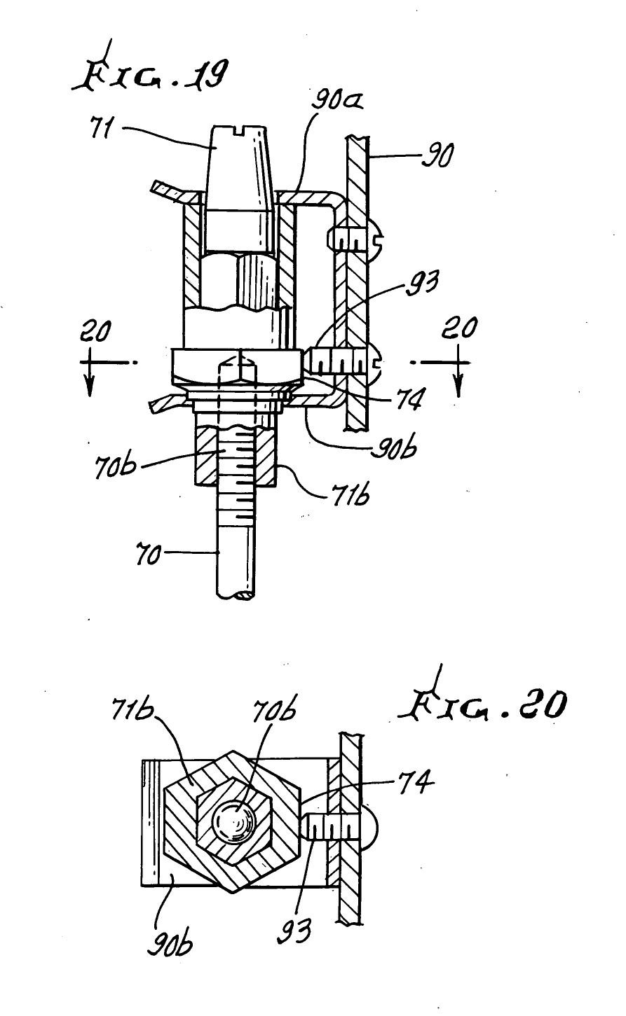

FIGS. 19 and 20 show a rotary adjustment means for positioning an auxiliary bolt 71 relative to a connecting door frame 90, having bracket flanges 90a and 90b. The upper end 70b of rod 70 is adjustment threaded into bolt lower structure 71b, whereby as rod 70 is adjustably rotated, the bolt is raised or lowered. An adjustable side fastener 93 engages a flat 94 on structure 71b, to keep that structure from rotating, once it has been adjusted. In FIG. 18, pins 91 on rod 70 release from grooves in 77a upon 90° rotation of 70, to “quick release” the connection.

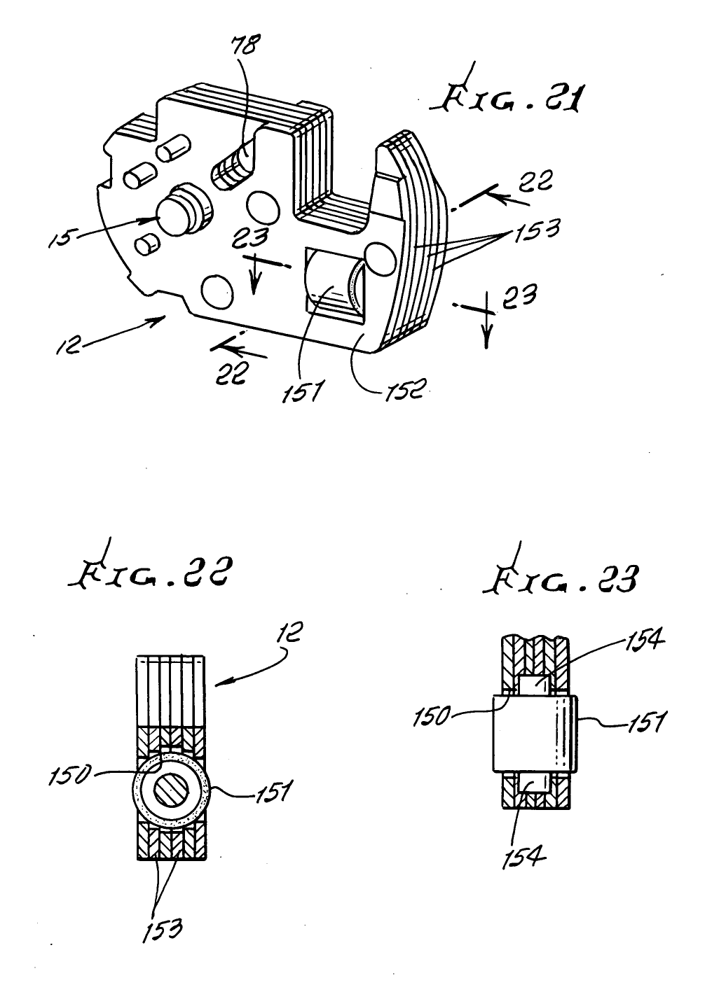

FIGS. 21-23 show details of the bolt structure, including the through opening 150, and the roller 151, received in that opening to protrude at opposite sides of the bolt body 152,
i) for rollable engagement with a confinement surface or surfaces associated with the casing,
ii) or, for engagement by a hack saw operated by an intruder, for blocking severing of the bolt.
   Laminations 153 form the bolt body and the opening 150. The roller may consist of ceramic material to resist lack saw teeth penetration. Cylindrical roller trunnions appear at 154.

What is claimed is:

1. In a lock drive train, the combination comprising
a) a pivoted lock bolt to be carried by a door,
b) a casing,
c) a rotary cylinder operatively rotatable during door opening or closing,
d) a rack driven endwise in response to cylinder rotation,
e) a gear rotatable by the driven rack,
f) a pivoted lock dog driven by the gear,
g) a bolt release lever, pivotable by the gear, between angular positions in which it is retained by the lock dog,
h) said angular positions corresponding to extended and retracted positions of the bolt.

2. The combination of claim 1 wherein the lock bolt has a through opening, and a roller received in said opening to protrude at opposite sides of said body,
i) for rollable engagement with a confinement surface or surfaces associated with the casing,
ii) or, for engagement by a hack saw operated by an intruder, for blocking severing of the bolt.

3. The combination of claim 1 including an elongated rod carried by the casing and having sections, and a quick release connection associated with said sections.

4. The combination of claim 1 wherein the cylinder has multiple peripheral threads, and including a cylinder casing housing the cylinder, and configured to be mounted within an opening in a door, and including a non-cantilevered locking set screw received in engagement with said threads.

5. The combination of claim 3 including a hexagonal linearly interfitting element carried by said respective section.

6. The combination of claim 4 including a casing faceplate having beveled edges interfitting corresponding edges defined by an opening in the casing, the faceplate being removable to provide access to said set screw, for adjustment.

7. The combination of claim 1 wherein the bolt has at least one tapered side surface to assure ease of interfit in the casing, as the bolt pivots.

8. The combination of claim 3 including a rod bracket to enable rod endwise sliding, the bracket located within the casing.

9. The combination of claim 1 including an elongated stile containing the casing, and spacers installed and located within the stile in response to relative sliding, for positioning the casing, said spacers configured to be adjustable in the field to retain said casing positioning in the stile, and a removable trim facing plate for the casing to conceal said spacers.

10. The combination of claim 9 including a dummy face plate on the stile used during said adjustable positioning to allow spacer alignment and positioning via a tool insertable in an opening or openings in the dummy face plate, that dummy face plate then being removable to allow installation of said trim face plate.

11. The combination of claim 1 wherein the lock dog has releasable interfit with the bolt, in bolt extended and retracted position, there being a lost motion connection between the gear and the bolt release lever whereby said interfit is released during gear rotation and prior to said pivoting of the release lever.

12. The combination of claim 11 including spring means biasing said lock dog to retain said releasable interfit, in bolt extended and retracted positions.

13. The combination of claim 1 including a casing for the rotary cylinder, to fit in a door opening, and means to retain the casing in any of plurality of selected horizontal positions in the door opening.

14. The combination of claim 13 wherein said means comprises a first set of tongue and groove elements at the door opening, and which are horizontally spaced, and at least one tongue or groove element or elements carried by the cylinder casing or door opening, to selectively interfit said first set.

15. The combination of claim 1 including a stile into which the lock casing is received, and means for adjusting the position of the casing relative to a stile wall, including a set screw carried by the lock casing and having threaded engagement with the casing whereby the screw exerts tightening force against the stile, the screw rotatable by an elongated adjuster projecting into the casing.

16. The combination of claim 1 including upper and lower elongated rod elements extending into the lock casing to be operatively connected to the lock bolt for extension as the bolt rotates, and upper and lower auxiliary bolts operatively connected to said rod elements at their terminals, to be displaced into door frame structure as the lock bolt is pivoted.

17. The combination of claim 16 including adjustment means operatively connected between the upper auxiliary bolt of the upper rod, allowing vertical adjustment of upper bolt positioning in response to rod rotation and fastener means to hold the adjustment means in position following adjustment.
